(19) United States
(12) Patent Application Publication
(10) Pub. No.: US 2008/0236023 A1
(43) Pub. Date: Oct. 2, 2008

(54) Automated pest-trapping device

(75) Inventors: John E. Thomas, River Falls, WI (US); James J. Tarara, Woodbury, MN (US)

Correspondence Address: ECOLAB INC., MAIL STOP ESC-F7, 655 LONE OAK DRIVE, EAGAN, MN, 55121, US

(73) Assignee: Ecolab Inc., Eagan, MN (US)

(21) Appl. No.: 11/729,380

(22) Filed: Mar. 28, 2007

(51) Int. Cl. A01M 23/00

(52) U.S. Cl. 43/58

(57) ABSTRACT

A pest-trapping device includes a frame, a catch mechanism sized to fully cover the frame, an actuator, and an optical sensor operatively connected to the actuator for detecting presence of a pest. The actuator moves the catch mechanism from a first position and a second position.

### BACKGROUND OF THE INVENTION

The present invention relates generally to the field of pest-trapping devices. In particular, the invention relates to an automated pest-trapping device.

Due to their size, small animals such as birds and rodents are able to easily enter and inhabit buildings while evading capture. For example, birds often enter warehouse buildings having tall ceilings to nest in the supporting structures of the building which are at a distance from normal human activity. One method currently used to trap birds located indoors uses a remote trigger to activate a net when a bird is observed to be within a trap zone. A problem with this method is that it requires that an operator constantly watch the trap to observe when a bird has entered the trap zone in order to activate the trap to catch the bird. This can be very time-consuming and utilizes valuable time that the operator could be spending on more productive activities. In an attempt to maximize the productivity of the operator, the trap may be positioned in a confined area so that the operator can also perform other activities while maintaining a watchful eye on the trap. However, birds are easily frightened and tend to avoid confined areas.

A second method currently used to trap birds uses a mechanical trigger to activate the trap when a bird is detected. These traps do not require the constant supervision of an operator and can be positioned in an unconfined, open area of a building. The mechanical trigger is typically connected to a balance holding bait, which maintains the trigger in a resting state by its weight. When a bird approaches the bait and varies the weight on the balance, the trigger is activated and a net is thrown over the bird. A problem associated with mechanical triggers is that they can be easily triggered, setting the trap off prematurely. Another concern with unattended traps is that the operator is not aware of when a bird has been trapped unless the operator frequently checks the trap, potentially allowing the bird to be trapped for an extended amount of time. Trapped birds can become easily stressed, causing harm and potentially death.

It would thus be beneficial to develop an automated pest-trapping system that allows the humane capture and release of the pest.

### BRIEF SUMMARY OF THE INVENTION

A pest-trapping device includes a frame, a catch mechanism sized to fully cover the frame, an actuator, and an optical sensor operatively connected to the actuator for detecting presence of a pest. The actuator moves the catch mechanism from a first position to a second position.

### BRIEF DESCRIPTION OF THE DRAWINGS

FIG. 1A is a front perspective view of a first embodiment of a pest-trapping device in an open position.

FIG. 1B is a side perspective view of the first embodiment of the pest-trapping device in an open position.

FIG. 2A is an enlarged perspective view of an actuator of the first embodiment of the pest-trapping device in a first position.

FIG. 2B is an enlarged perspective view of the actuator of the first embodiment of the pest-trapping device in a second position.

FIG. 3 is an enlarged perspective view of a transmitter of the first embodiment of the pest-trapping device.

FIG. 4 is a front perspective view of the first embodiment of the first embodiment of the pest-trapping device in a closed position.

FIG. 5 is a functional block diagram of electrical components of the pest-trapping device.

FIG. 6 is a side perspective view of a second embodiment of the pest-trapping device in an open position.

FIG. 7 is a side perspective view of the second embodiment of the pest-trapping device in a closed position.

### DETAILED DESCRIPTION

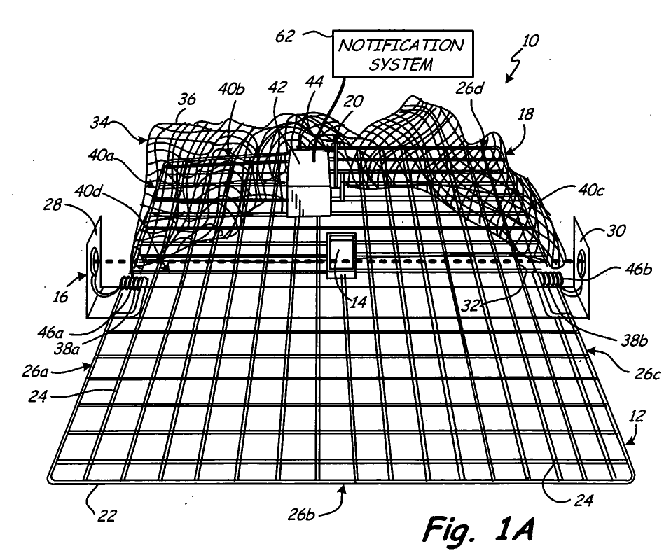

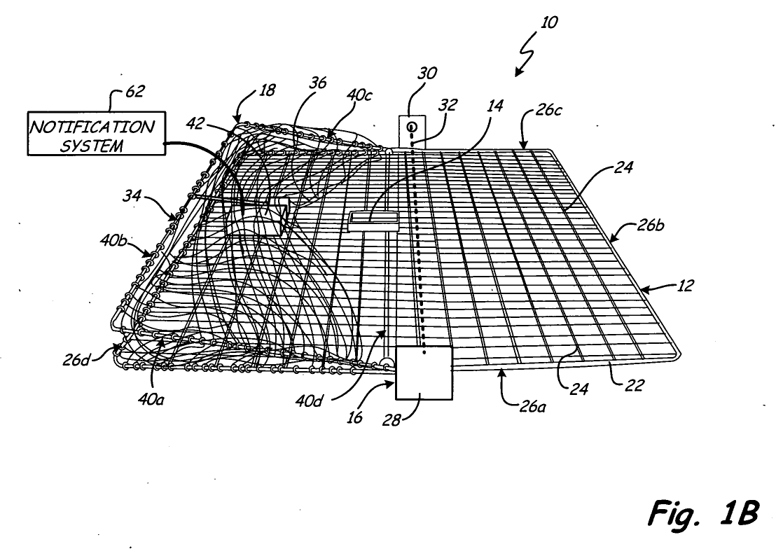

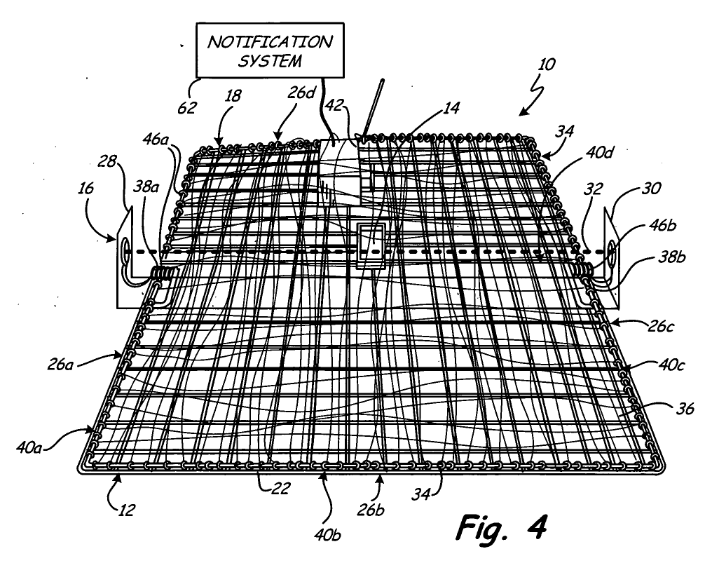

FIG. 1A shows a front perspective view of a first embodiment of pest-trapping device 10 in a first, open position. FIG. 1B shows a side perspective view of the first embodiment of pest-trapping device 10 in the first position, and will be discussed in conjunction with FIG. 1. Pest-trapping device 10 provides a convenient and relatively inexpensive method of capturing pests and generally includes base 12, bait tray 14, optical sensor 16, catch mechanism 18, and actuator 20. Sensor 16 is used in place of a mechanical trigger to activate pest-trapping device 10 and is connected to actuator 20, which triggers catch mechanism 18. Sensor 16 triggers catch mechanism 18 only when a pest is in close proximity to bait tray 14, making it less likely that catch mechanism 18 will be falsely triggered. Pest-trapping device 10 is movable between a first (open) position and a second (closed) position. In the first position, pest-trapping device 10 exposes bait tray 14 to lure a pest onto base 12. Once a pest has been detected on base 12, pest-trapping device 10 moves to the second position (shown in FIG. 4), trapping the pest within catch mechanism 18. Catch mechanism 18 provides a humane method of capturing pests by allowing the pest to be released after it has been caught. Pest-trapping device 10 may be used to trap various types of pests, such as birds, rodents, and other small mammals.

Base 12 of pest-trapping device 10 provides a foundation for setting bait tray 14, sensor 16, catch mechanism 18, and actuator 20 and generally includes frame 22 and plurality of wires 24. Frame 22 has first side 26a, second side 26b, third side 26c, and fourth side 26d. Wires 24 are arranged between frame 22 in two parallel arrays that intersect each other at approximately right angles. Base 12 may be formed of any material that is capable of maintaining the targeted pest within pest-trapping device 10. For example, if the targeted pest is a rodent, base 12 may be formed of metal to prevent the rodent from chewing through base 12 and escaping. In addition, depending on the targeted pest, wires 24 may be spaced apart from each other at varying distances to ensure that the pest cannot squeeze through wires 24. Generally, the larger the targeted pest, the farther apart wires 24 may be spaced from one another. For example, if the targeted pest is a small mammal such as a raccoon, wires 24 may be spaced farther apart. If the targeted pest is a bird or a small rodent, wires 24 will be spaced closer together. This may provide an economical advantage with regard to the cost of materials required for constructing pest-trapping device 10. In an exemplary embodiment, base 12 is approximately 3 feet wide by approximately 3 feet long. Although base 12 is depicted in FIG. 1 as being rectangular in shape, base 12 may take any shape without departing from the intended scope of the invention. In addition, although wires 24 are depicted in FIG. 1 as two intersecting parallel arrays, wires 24 may be arranged in any pattern without departing from the intended scope of the invention. For example, wires 24 may form a crossed array, or a parallel and crossed mixed array.

Bait tray 14 is positioned within base 12 and is positioned generally equally spaced from first side 26a, second side 26b, third side 26c, and fourth side 26d of frame 22 to provide a higher likelihood of catching the pest and a lower likelihood of inadvertently harming the pest. Bait tray 14 may be filled with any bait that is desirable to the targeted pest. For example, if the targeted pest is a bird, bait tray 14 may be filled with water, nuts, corn, grain, etc. In addition, although FIGS. 1A, 1B, and 4 depict pest-trapping device 10 as including bait tray 14, pest-trapping device 10 may optionally not include bait tray 14.

Optical sensor 16 generally includes transmitter 28 and receiver 30. In an exemplary embodiment, optical sensor 16 is an infrared (IR) sensor. Transmitter 28 is positioned at first side 26a of frame 22 and transmits IR beam 32 towards receiver 30, which is positioned at third side 26c of frame 22 directly across from transmitter 28. Transmitter 28 and receiver 30 must be positioned relative to one another such that the area directly between them is unobstructed. It is essential that IR beam 32 can be transmitted from transmitter 28 to receiver 30 without disruption. Bait tray 14 is typically positioned between transmitter 28 and receiver 30 proximate the path of IR beam 32. However, because IR beam 32 must be able to reach receiver 30 from transmitter 28, if bait tray 14 is positioned directly in between transmitter 28 and receiver 30, IR beam 32 is transmitted at a height greater than the height of bait tray 14. Optionally, bait tray 14 may also be positioned slightly offset from transmitter 28 and receiver 30. Although transmitter 28 and receiver 30 are depicted as being positioned at the center of first side 26a and third side 26c of base 12, transmitter 28 and receiver 30 may be positioned anywhere around the perimeter of frame 22 as long as they are positioned directly across from one another to ensure that IR beam 32 can be transmitted from transmitter 28 to receiver 30.

Any suitable transmitter 28 and receiver 30 may be used. Factors to consider in selecting transmitter 28 and receiver 30 include, but are not limited to: operation in light and dark environments, temperature resistance, and voltage fluctuation rejection. An example of a commercially suitable transmitter 28 and receiver 30 are designated SE61E and SE61R, respectively, available from Banner Engineering Corporation, Minneapolis, Minn. Although sensor 16 is discussed as being an IR sensor, sensor 16 may be any type of optical sensor without departing from the intended scope of the present invention.

Catch mechanism 18 generally includes foldable frame 34, netting 36, and first pivot joint 38a and second pivot joint 38b (collectively referred to as pivot joints 38). Catch mechanism 18 is foldable over base 12 between a first (folded) position and a second (unfolded) position. When pest-trapping device 10 is in the open position, catch mechanism 18 is pulled back to expose a portion of base 12 and bait tray 14 and is held in this position by actuator 20. Foldable frame 34 includes first side 40a, second side 40b, third side 40c, and fourth side 40d and is approximately one half the size of frame 22 of base 12. Foldable frame 34 of catch mechanism 18 is initially positioned over frame 22 of base 12 such that first side 40a of frame 34 is aligned with first side 26a of base 12, second side 40b of foldable frame 34 is aligned with second side 26b of base 12, third side 40c of foldable frame 34 is aligned with third side 26c of base 12, and fourth side 40d of foldable frame 34 is positioned in the center of base 12 parallel with first and fourth sides 26a and 26d of base 12. Netting 36 is connected to first, second, and third sides 40a-40c of foldable frame 34 and a portion of first side 26a, a portion of third side 26c, and fourth side 26d of base 12. Netting 36 is sized to fully cover base 12 and is preferably larger than the dimensions of base 12 in order to allow a trapped pest room to move within pest-trapping device 10 when pest-trapping device 10 is in the closed position. As with wires 24 of base 12, netting 36 is made of a material designed to retain the pest within pest-trapping device 10 and will vary depending on the targeted pest.

Foldable frame 34 is connected to frame 22 of base 12 at pivot joints 38 and is movable between a first position and a second position about pivot joints 38 and fourth side 40d of foldable frame 34. First pivot joint 38a is located at the intersection of first side 40a of foldable frame 34, fourth side 40d of foldable frame 34, and first side 26a of frame 22. Second pivot joint 38b is located at the intersection of third side 40c of foldable frame 34, fourth side 40d of foldable frame 34, and second side 26b of frame 22. Thus, fourth side 40d of foldable frame 34 is pivotally connected to base 12 along the center of base 12 at pivot joints 38. In the first position, second side 40b of foldable frame 34 is aligned with fourth side 26d of frame 22. In the second position, second side 40b of foldable frame 34 is aligned with second side 26b of frame 22. To position foldable frame 34 in the first position, foldable frame 34 is pivoted about pivot joints 38 such that second side 40b of foldable frame 34 pivots away from second side 26b of frame 22 of base 12 and towards fourth side 26d of frame 22 of base 12. Although foldable frame 34 is depicted in FIG. 1 and is discussed as having fourth side 40d at the center of base 12, foldable frame 34 may optionally exclude fourth side 40d and be connected to first and second pivot joints 38a and 38b by extensions from first and third sides 40a and 40c, respectively.

Actuator 20 maintains catch mechanism 18 in the folded position with second side 40b of foldable frame 34 aligned with fourth side 26d of frame 22 of base 12. Actuator 20 generally includes solenoid 42, latch mechanism 44, and first spring 46a and second spring 46b (collectively referred to as springs 46). Latch mechanism 44 is connected to fourth side 26d of frame 22 of base 12 and is engagable with solenoid 42 and maintains catch mechanism 18 in the folded position. First spring 46a is located at first pivot joint 38a and second spring 46b is located at second pivot joint 38b directly opposite first spring 46a. As foldable frame 34 pivots about pivot joints 38 to the first position, springs 46 become loaded and are held back only by latch mechanism 44.

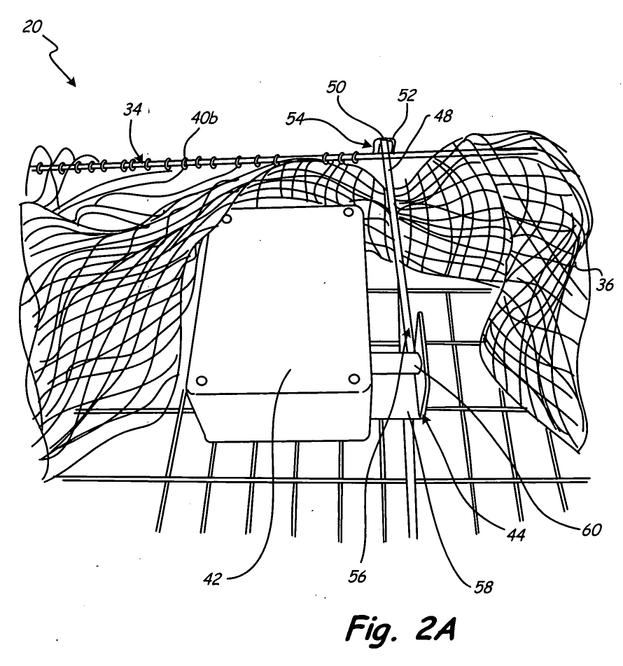

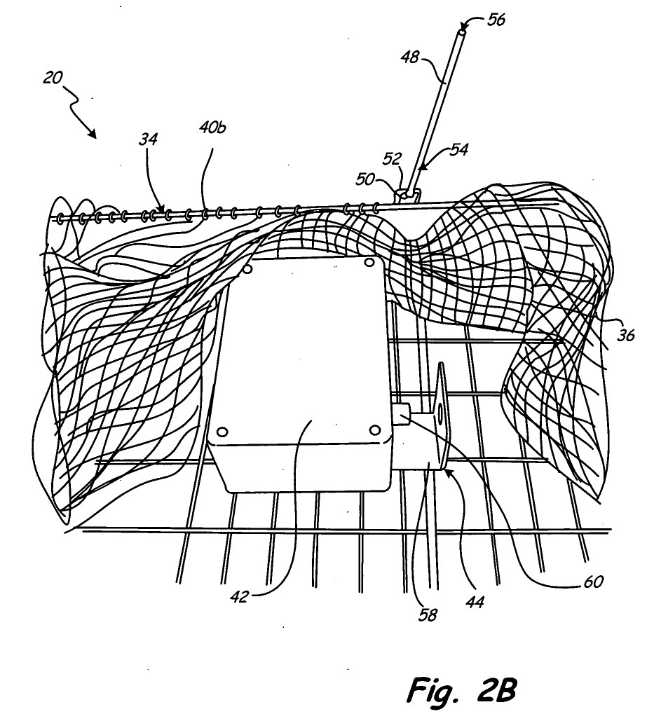

FIGS. 2A and 2B show an enlarged perspective view of actuator 20 with latch mechanism 44 in a first position and a second position, respectively, and will be discussed in conjunction with each other. In an exemplary embodiment, latch mechanism 44 includes arm 48, hook 50, and loop 52. Arm 48 has a first end 54 ending in hook 50 and a second end 56 engagable with solenoid 42 and thus has a length sufficient to extend from fourth side 26d of frame 22 of base 12 to solenoid 42. Loop 52 is connected to fourth side 26d of frame 22 of base 12 and pivotally attaches hook 50 to base 12. When the first embodiment of pest-trapping device 10 is in the first position (FIG. 2A), second end 56 of arm 48 is engaged with solenoid 42 and retains second side 40b of foldable frame 34 to fourth side 26d of frame 22 of base 12.

As previously mentioned, arm 48 extends from loop 52 to solenoid 42, which is movable between a first position and a second position. Solenoid 42 includes support structure 58 and retractable element 60. Support structure 58 stabilizes retractable element 60 to solenoid 42 and in combination with retractable element 60, functions to retain second side 40b of foldable frame 34 to fourth side 26d of frame 12 when solenoid 42 is in the first position. Second end 56 of arm 48 is engagable with retractable element 60 of solenoid 42 and is pinned under retractable element 60 when solenoid 42 is in the first position. With second end 56 of arm 48 engaged with retractable element 60, foldable frame 34 is maintained in the folded position. When actuator 20 is triggered, solenoid 42 moves to the second position, retracting retractable element 60 inward towards solenoid 42 and releasing second end 56 of arm 48 (FIG. 2B). As second end 56 of arm 48 is freed from under retractable element 60, loaded springs 46 force two simultaneous actions. Second side 40b of foldable frame 34 pivots about pivot joints 38 towards second side 26b of frame 22 of base 12 and first end 54 of arm 48 pivots about hook 50 and loop 52 in the opposite direction as foldable frame 34. Although FIGS. 2A and 2B depict latch mechanism 44 as including a hook and loop to pivotally mount arm 48, any latch mechanism known in the art may be used without departing from the intended scope of the present invention.

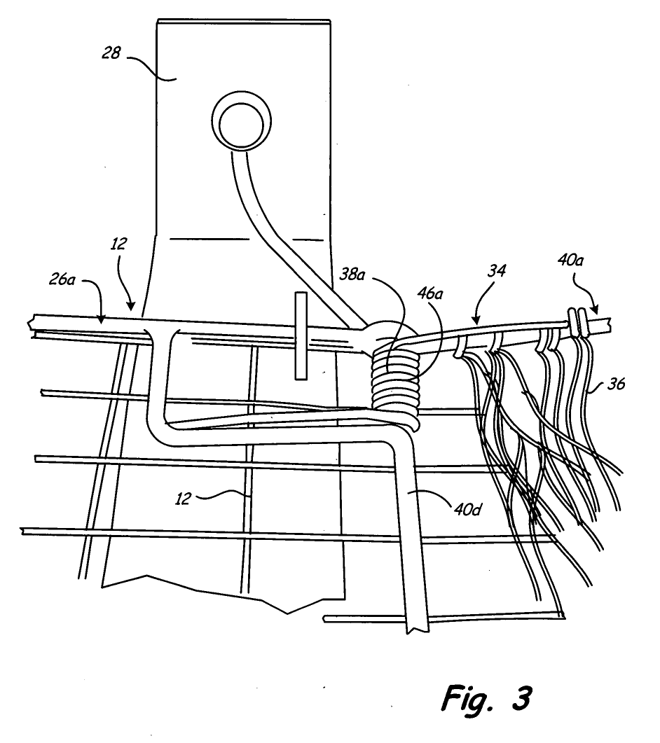

FIG. 3 shows an enlarged, perspective view of first pivot joint 38a of catch mechanism 18. Second pivot joint 38b operates in the same manner as first pivot joint 38a. FIG. 4 shows a perspective view of the first embodiment of pest-trapping device 10 in the second, closed position and will be discussed in conjunction with FIG. 3. In operation, when the path of IR beam 32 between transmitter 28 and receiver 30 becomes obstructed, actuator 20 is triggered, releasing second side 40b of foldable frame 34 of catch mechanism 18 and actuating springs 46. Once second side 40b of foldable frame 34 is released, springs 46 drive foldable frame 34 from the first position to the second position. As previously mentioned, when foldable frame 34 is initially set in the first-position and pivoted away from second side 26b of frame 22 and towards fourth side 26d of frame 22, springs 46 become loaded. Thus, upon release of second side 40b of foldable frame 34, springs 46 quickly force second side 40b of foldable frame 34 away from fourth side 26d and toward second side 26b of frame 22 to the second position. In the second position, second sides 26b and 40b of frame 22 and foldable frame 34, respectively, are aligned with one another. Catch mechanism 18 is in the unfolded position with netting 36 completely covering base 12, trapping the pest within base 12 and catch mechanism 18. In the resting state, springs 46 provide enough resistance to maintain foldable frame 34 in the unfolded position when subjected to force by a small pest trapped within catch mechanism 18. Pest-trapping device 10 remains in this position until an operator reattaches second side 40b of foldable frame 34 to fourth side 26d of frame 22 with latch mechanism 44.

Pest-trapping device 10 may also optionally include a notification system 62 for sending a signal to a remote location when catch mechanism 18 has been triggered. For example, notification system 62 may send a message through a cellular network or paging system. Notification system 62 minimizes the time a trapped pest spends in pest-trapping device 10, allowing for quicker release and improving the humane feature of trapping live animals.

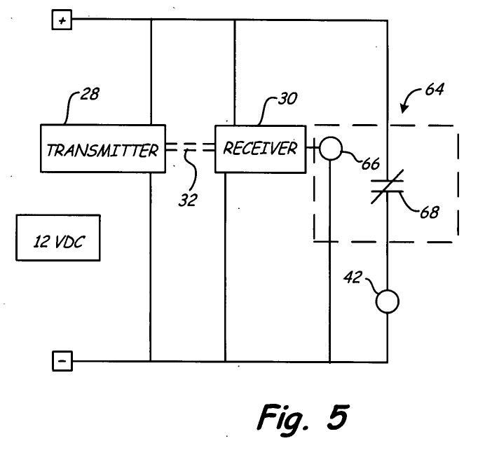

FIG. 5 shows a functional block diagram of electrical components of pest-trapping device 10 with transmitter 28 sending IR beam 32 (shown in FIG. 1) toward receiver 30, generally including transmitter 28, receiver 30, IR beam 32, relay 64, and solenoid 42. Transmitter 28 generates IR beam 32 toward an operative light sensitive surface of receiver 30. Receiver 30 is normally on (i.e., it acts as a switch which turns off when IR beam 32 is not detected by the surface of receiver) and is operatively connected to relay 60. Relay 64 generally includes relay coil 66 and relay contact 68. When receiver 30 is on, current flows to relay coil 66, which maintains relay contact 68 in an open position. Relay contact 68 is normally closed, and is held in the open position by relay coil 66 when relay coil 66 is receiving current. When relay contact 68 is in the open position, power is not supplied to solenoid 42 and solenoid 42 is in the off position. In the off position, solenoid 42 maintains actuator 20 (shown in FIGS. 1 and 2) in the first position and thus, maintains catch mechanism 18 in the first position.

When an obstruction, such as a pest, comes into the path of transmitter 28 and receiver 30, IR beam 32 breaks and cannot reach receiver 30. When IR beam 32 is broken, receiver 30 is “switched” off and closes relay coil 66 such that there is no longer any current going from receiver 30 to relay coil 66. Because no current is reaching relay coil 66, relay coil 66 closes, closing relay contact 68. When relay contact 68 is closed, current is allowed to flow to solenoid 42. As the current reaches solenoid 42, solenoid 42 becomes energized and drives retractable element 60 inward to release second end 56 of arm 48. This allows first end 54 of arm 48 to pivot about hook 50 and loop 52, releasing second side 40b of foldable frame 34 of catch mechanism 18 from base 12. Springs 46 drive second side 40b of foldable frame 34 away from fourth side 26d of frame 22 and towards second side 26b of frame 22. The electrical components of pest-trapping device 10 may be powered by either a power outlet or a battery. In an exemplary embodiment, the electrical components used are a 12 VDC relay, a 12 VDC solenoid, and a 12 VDC transformer. Although relay coil 66 is discussed as initially being open when IR beam 32 reaches receiver 30, relay coil 66 may also be normally closed when IR beam 32 reaches receiver 30 without departing from the intended scope of the present invention. Likewise, although relay contact 68 is discussed as initially being normally closed, relay contact 68 may also be normally open with solenoid 42 receiving power to remain in the first position and breaking off power to solenoid 42 when IR beam 32 is disrupted without departing from the intended scope of the present invention.

In operation, pest-trapping device 10 is initially positioned in the first, open position by pivoting foldable frame 34 about pivots 38 and loading springs 46. In the open position, second side 40b of foldable frame 34 of catch mechanism 18 is positioned over fourth side 26d of frame 22 of base 12. Pest-trapping device 10 is maintained in this position by latch mechanism 44 of actuator 20. Once pest-trapping device 10 in the first position, bait tray 14 is filled with bait and positioned on base 12. Infrared (IR) beam 32 is then transmitted from transmitter 28 to receiver 30 at least partially over bait tray 14 or proximate bait tray 14. As long as receiver 30 detects IR beam 32, relay 64 maintains solenoid 42, and actuator 20, in the first position. When IR beam 32 is disrupted, solenoid 42 is powered on and retracts retractable element 60 of latch mechanism 44. The retraction of retractable element 60 disengages second end 56 of arm 48 from solenoid 42 and triggers springs 46 of actuator 20. Springs 46 drive catch mechanism 18 to the unfolded position with netting 36 covering base 12. Optionally, a signal may be sent to a remote location upon disruption of IR beam 32 by notification system 62 to inform an operator that catch mechanism 18 of pest-trapping device 10 has been activated.

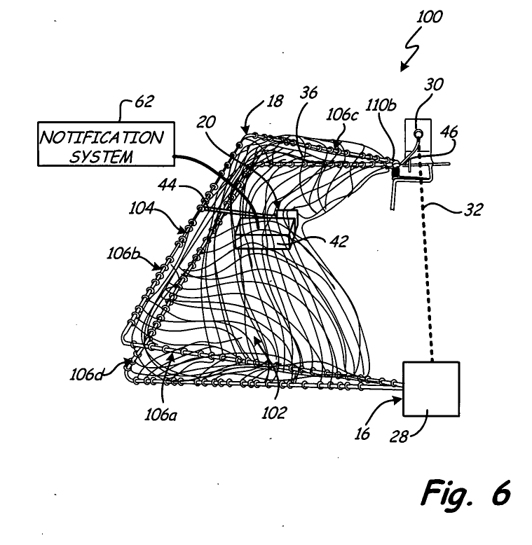

FIG. 6 shows a side perspective view of a second embodiment of pest-trapping device 100 in an open position. The second embodiment of pest-trapping device 100 includes optical sensor 16, catch mechanism 102, and actuator 20 and operates similarly to optical sensor 16, catch mechanism 18, and actuator 20 of the first embodiment of pest-trapping device 10. The only difference between the first and second embodiments of pest-trapping devices 10 and 100 is that the second embodiment of pest-trapping device 100 does not include a base and catch mechanism 102 operates differently. The base is removed so that the pest to be captured, which may be a timid or apprehensive creature, may be less intimidated and more likely to approach pest-trapping device 100 with the removal of base 12 and wires 24 (shown in FIGS. 1A, 1B, and 4).

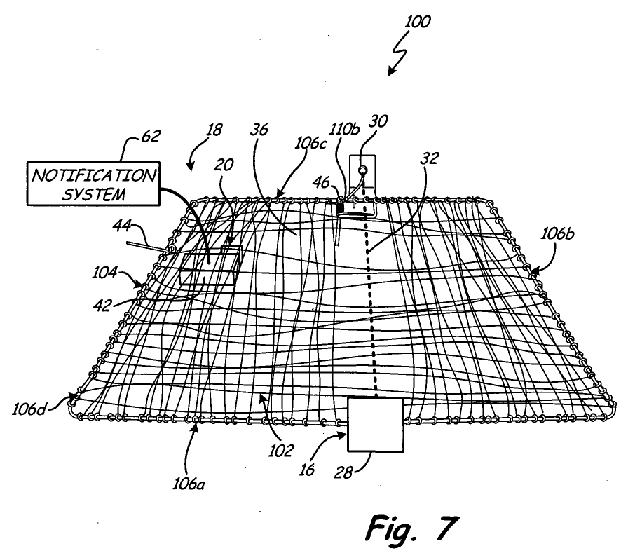

In operation, the second embodiment of pest-trapping device 100 functions the same as the first embodiment of pest-trapping device 10. Catch mechanism 102 includes foldable frame 104 that is movable between an open position and a closed position (shown in FIG. 7). Foldable frame 104 includes first side 106a, second side 106b, third side 106c, fourth side 106d, and netting 108. First side 106a and third side 106c of foldable frame 104 are foldable at first pivot 110a (not shown) and second pivot 110b, respectively, which are connected to springs 46 of actuator 20. When catch mechanism 102 is in the open position, foldable frame 104 is folded such that second side 106b and fourth side 106d of foldable frame 104 are proximate one another. When catch mechanism 102 is in the closed position, foldable frame 104 is unfolded such that sides 106a-106d of foldable frame 104 are flush with the floor. Pest-trapping device 100 is initially positioned in the open position by pivoting foldable frame 104 of catch mechanism 102 about pivots 110a and 110b and loading springs 46. Pest-trapping device 100 is maintained in this position by latch mechanism 44 of actuator 20. IR beam 32 is then transmitted from transmitter 28 to receiver 30. In the open position, netting 36 of catch mechanism 104 is pulled back and exposes the area proximate IR beam 32. Bait may be scattered on the floor close to infrared beam 32 so that when a pest disrupts infrared beam 32, catch mechanism 102 moves to the closed position. Bait tray 14 (shown in FIG. 1) may also optionally be positioned proximate infrared beam 32.

FIG. 7 shows a side perspective view of the second embodiment of pest-trapping device 100 in the closed position. When IR beam 32 is disrupted, solenoid 42 is powered on and retracts retractable element 60 of latch mechanism 44, triggering springs 46 of actuator 20. Springs 46 drive catch mechanism 102 to an unfolded position with netting 36 covering the floor on which pest-trapping device 100 is placed. Because edges 106a-106d of foldable frame 104 are flush with the floor, any pest trapped within netting 36 cannot escape. In an exemplary embodiment, pest trapping device 100 weights approximately 3.3 pounds and springs 46 have a force of approximately 1 pound. In another exemplary embodiment, pest trapping device 10 weights approximately 5 pounds and springs 46 have a pressure of approximately 2.5 pounds. In another exemplary embodiment, pest trapping device 100 weights approximately 8.7 pounds and springs 46 have a force of approximately 4 pounds. Similar to the first embodiment of pest-trapping device 10, notification system 62 may be connected to actuator 20 to send a signal to a remote location upon disruption of IR beam 32 when pest-trapping device 100 has been activated.

The pest-trapping device traps pests humanely and without the need of an operator continuously monitoring the pest-trapping device. The pest-trapping device generally includes a base, an optical sensor, a catch mechanism, and an actuator. The optical sensor transmits an optical beam over the base and replaces the need for a mechanical trigger. When the beam is disrupted, it triggers the actuator, which normally holds the catch mechanism in an open position. The catch mechanism is movable between a first (open) position and a second (closed) position. In the first position, the pest-trapping device exposes bait used to lure a pest. When the pest enters the base and disrupts the optical beam, the pest-trapping device moves to the second position and traps the pest within the catch mechanism. A notification system may be operatively connected to the pest-trapping device to send notification to an operator once the catch mechanism has been triggered. The pest may be released after it has been caught.

Although the present invention has been described with reference to preferred embodiments, workers skilled in the art will recognize that changes may be made in form and detail without departing from the spirit and scope of the invention.

1. A pest-trapping device comprising:
(a) a frame;
(b) a catch mechanism sized to fully cover the frame, wherein the catch mechanism is movable between a first position and a second position;
(c) an optical sensor for detecting presence of a pest; and
(d) an actuator for moving the catch mechanism from the first position to the second position in response to the optical sensor detecting presence of a pest.

2. The pest-trapping device of claim 1, wherein the catch mechanism is a net.

3. The pest-trapping device of claim 1, wherein the actuator comprises:
(a) a latch mechanism for maintaining the catch mechanism in the first position when the latch mechanism is in a latched condition;
(b) a solenoid for holding the latch mechanism in the latched condition and for releasing the latch mechanism upon detection of a pest by the optical detector; and
(c) at least one spring for driving the catch mechanism from the first position to the second position when the latch mechanism is released.

4. The pest-trapping device of claim 3, wherein the latch mechanism comprises:
(a) an arm having a first end and a second end, wherein the first end of the arm is connected to the solenoid;
(b) a hook connected to the second end of the arm; and
(c) a loop engagable with the hook.

5. The pest-trapping device of claim 1, wherein the frame is between about 18 inches by about 18 inches and about 36 inches by about 36 inches in size.

6. The pest-trapping device of claim 1, wherein the optical sensor comprises:
(a) a transmitter;
(b) a receiver positioned opposite the transmitter;
(c) an optical beam created between the transmitter and the receiver;
(d) a relay operatively connected to the receiver; and
(e) a solenoid operatively connected to the relay for releasing the catch mechanism from the first position to the second position in response to a signal from the relay.

7. The pest-trapping device of claim 6, and further comprising a base connected to the frame.

8. The pest-trapping device of claim 6, and further comprising a bait tray positioned over the base.

9. The pest-trapping device of claim 8, wherein the optical beam is transmitted over the bait tray.

10. An automated device for trapping pests, the automated device comprising:
(a) a frame pivotable between a first position and a second position;
(b) a net positioned within the frame;
(c) an infrared (IR) system for detecting presence of a pest and creating a first signal when the presence of a pest is detected;
(d) a latch mechanism for maintaining the frame in the first position and for releasing the frame from the first position in response to the first signal from the IR system; and
(e) a bias force for driving the frame from the first position to the second position when the latch mechanism releases the frame.

11. The automated device of claim 10, wherein the bias force comprises at least one spring.

12. The automated device of claim 10, and further comprising a notification system for sending a second signal to a remote location when the frame is in the second position.

13. The automated device of claim 10, wherein the IR system comprises:
(a) a transmitter;
(b) a receiver positioned opposite the transmitter;
(c) an IR beam created between the transmitter and the receiver;
(d) a relay operatively connected to the receiver; and
(e) a solenoid operatively connected to the relay for releasing the frame from the first position.

14. The automated device of claim 13, and further comprising a bait tray positioned on the frame.

15. The automated device of claim 13, wherein the relay is switchable between a first position and a second position, and wherein the solenoid releases the frame from the first position in response to the relay switching from the first position to the second position.

16. A method of trapping pests comprising:
(a) transmitting a continuous optical beam between a transmitter and a receiver;
(b) releasing a latch mechanism in response to a disruption in the optical beam; and
(c) covering an area with a catch mechanism upon release of the latch mechanism.

17. The method of claim 16, and further comprising positioning a bait tray within the area and transmitting a continuous optical beam comprises transmitting the optical beam proximate the bait tray.

18. The method of claim 16, and further comprising sending a signal to a remote location upon release of the latch mechanism.

19. The method of claim 16, wherein the disruption in the optical beam is caused by presence of a pest.

20. The method of claim 16, wherein releasing the latch mechanism comprises activating a solenoid.
